(19) United States
(12) Patent Application Publication
(10) Pub. No.: US 2008/0089586 A1
(43) Pub. Date: Apr. 17, 2008

(54) Data processing system, data processing terminal and data processing program of digital pen

(75) Inventors: Naoyuki Igarashi, Osaka (JP); Hidefumi Goto, Osaka (JP); Ayako Kinoshita, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/907,282

(22) Filed: Oct. 10, 2007

(30) Foreign Application Priority Data
Oct. 11, 2006 (JP) 2006-277711

(51) Int. Cl. G06F 17/00

(52) U.S. Cl. 382/187

(57) ABSTRACT

In a data processing system, a terminal includes an area definition storage unit to store position information of a specific area on a paper and processing type information indicating a processing type of data written in the specific area in association with each other, a first data processing unit to generate handwritten information by analyzing address data captured by the digital pen and extract handwritten information in a specific area based on position information of the specific area stored in the area definition storage unit, and a second data processing unit to execute data processing on the extracted handwritten information based on processing type information associated with the position information of the specific area in the area definition storage unit and store processed data into a database accessible by a user application.

### BACKGROUND OF THE INVENTION

1. Field of the Invention

The present invention relates to a data processing system, a data processing terminal and a data processing program of a digital pen.

2. Description of Related Art

A technique of using a digital pen is proposed as a method for digitizing handwritten information. Digitizing handwritten information, which is analog data, facilitates the sharing and accumulation of information, increases the speed of information transmission, and so on.

There are various techniques for the digitization with the use of the digital pen. For example, one technique uses a special digital pen and a special paper having a particular pattern printed on its surface. When a user writes information on the paper using the digital pen, the digital pen recognizes the pattern to thereby digitize the handwritten information.

The pattern that is recognized by the digital pen is captured as coordinate information or the like of handwritten information, and a user application processes the handwritten information captured by the digital pen independently for each specific area of the special paper and displays a desired result.

A user application acquires handwritten information as data with a format designed for a specific purpose based on predefined area definition information. Position information of a specific area on a special paper is defined as the area definition information.

A user application acquires handwritten information data of each specific area based on such predefined area definition information. The user application then processes the acquired handwritten information data. For example, the user application may process the handwritten information as binary data to indicate the presence or absence of handwritten information in a certain specific area, process the handwritten information in a certain specific area as image information as drawn, process the handwritten information in a certain specific area to be recognized as characters or graphics, or process the handwritten information in a certain specific area as coordinate information.

FIG. 1 is a block diagram showing the configuration of a data processing system of the digital pen using such area definition information. An area definition storage unit 240 stores area definition information that defines position information of each specific area on a special paper 20.

A digital pen 100 accesses a digital pen base system 200 of a PC 2 through a pen connection driver 210 and transmits address data of handwritten information that is captured by the digital pen 100. An address data analysis unit 222 of a data processing unit 220 receives the address data from the digital pen 100 and analyzes which special paper 20 the received address data is written on. A handwritten data analysis unit 221 of the data processing unit 220 extracts the address data in a specific area as handwritten information data based on the position information of a specific area that is stored in the area definition storage unit 240.

If the analysis result of the address data analysis unit 222 shows that the received address data is address data of the special paper 20 that corresponds to a user application A 500, a notification that notifies the presence of data to be processed by the user application A 500 is sent to the user application A 500.

A data processing unit 520 of the user application A 500 accesses a data access API (Application Program Interface) 250 and acquires the handwritten information data that is extracted by the handwritten data analysis unit 221. At this time, the data processing unit 520 of the user application A 500 can acquire the handwritten information data that is input by the digital pen 100 for each specific area on the special paper 20 by referring to the area definition information that is stored in the area definition storage unit 240.

The data processing unit 520 processes the handwritten information data that is extracted by the handwritten data analysis unit 221 for each area in a particular format. For example, it may process the data as binary data, process the data as image information as drawn, process the data to be recognized as characters or graphics, or process the data as coordinate information. After that, the user application A 500 stores the handwritten information data that is processed by the data processing unit 520 into a data storage unit 530 and, if necessary, displays a processing result using a data display unit 510.

As described above, the data processing system of the digital pen according to a related art shown in FIG. 1 needs to give an area definition to a specific area that is formed on each special paper and then places a data processing unit to perform processing for obtaining handwritten information data in a desired format based on the area definition information and a data storage unit to store the handwritten information data that is processed by the data processing unit for each user application. It is thus necessary in the data processing system of the related art to design and install a program that specifies a method of obtaining and storing handwritten information data with a particular way of processing independently for each user application, which requires a complicated process for each user application.

On the other hand, various techniques to perform processing by associating position information of a specific area on a special paper with a processing method of handwritten information data that is input onto the area are proposed. For example, Japanese Unexamined Patent Application Publication No. 2005-346415 discloses one of those techniques. However, the editing system using an electronic pen which is disclosed therein associates a specific area with a processing method of handwritten information data input onto the area afterwards, and it is thus different from a technique that associates position information of a specific area with a processing method of handwritten information data that is input onto the area, on which the present invention is based. Further, the present invention aims at providing a data processing system of the digital pen which enables easy implementation of a user application, which also differentiates the present invention from the related art.

As described in the foregoing, because the data processing system of the digital pen according to a related art processes and stores handwritten information data that is input using the digital pen with a particular method for each user application, it is necessary to independently design and install a program that specifies the processing method and the storage method. This raises the need for a complicated process for each user application, which hampers the implementation of a user application using handwritten information with the digital pen.

The present invention has been accomplished to solve the above problems and an object of the present invention is thus to provide a data processing system of the digital pen that enables easy implementation of a user application using handwritten information with the digital pen.

### SUMMARY OF THE INVENTION

According to an aspect of the present invention, there is provided a data processing system of a digital pen. The data processing system includes a paper where address data is printed, the digital pen to capture address data printed on the paper, and a terminal connected to be communicable with the digital pen so as to obtain the address data from the digital pen. The terminal includes an area definition storage unit to store position information of a specific area on the paper and processing type information indicating a processing type of data written in the specific area in association with each other, a first data processing unit (e.g. the data processing unit 220 in an embodiment of the present invention) to generate handwritten information by analyzing the address data captured by the digital pen and extract handwritten information in a specific area based on position information of the specific area stored in the area definition storage unit, and a second data processing unit (e.g. a data process component 700 in an embodiment of the present invention) to execute data processing on the extracted handwritten information based on processing type information associated with the position information of the specific area in the area definition storage unit and store processed data into a database accessible by a user application.

This configuration eliminates the need for designing and installing a program to provide a method of processing and storing handwritten information input by the digital pen in a particular method independently for each user application, thereby enabling easy implementation of a user application that uses handwritten information by the digital pen.

In the above data processing system, the area definition storage unit may further store identification information of the specific area in association with the position information of the specific area and the processing type information.

This configuration enables easier identification of an association between handwritten information data input by the digital pen and a specific area.

In the above data processing system, the second data processing unit may store the identification information of the specific area in association with processed data into the database.

This configuration allows a user application that accesses a database to easily identify an association between handwritten information data input by the digital pen and a specific area.

In the above data processing system, the processing type information stored in the area definition storage unit may be information that is selected by a user from a predetermined plurality of pieces of processing type information.

In the above data processing system, the processing type information that is stored in the area definition storage unit may contain any one of processing to convert the handwritten information into image information, processing to convert the handwritten information into stroke information, processing to convert the handwritten information into character recognition information, and processing to convert the handwritten information into information indicating presence or absence of handwritten information in the specific area.

According to another aspect of the present invention, there is provided a data processing terminal of the digital pen which is connected to be communicable with the digital pen for capturing address data printed on a paper so as to obtain the address data from the digital pen. The data processing terminal includes an area definition storage unit to store position information of a specific area on the paper and processing type information indicating a processing type of data written in the specific area in association with each other, a first data processing unit (e.g. the data processing unit 220 in an embodiment of the present invention) to generate handwritten information by analyzing the address data captured by the digital pen and extract handwritten information in a specific area based on position information of the specific area stored in the area definition storage unit, and a second data processing unit (e.g. a data process component 700 in an embodiment of the present invention) to execute data processing on the extracted handwritten information based on processing type information associated with the position information of the specific area in the area definition storage unit and store processed data into a database accessible by a user application.

This configuration eliminates the need for designing and installing a program to provide a method of processing and storing handwritten information input by the digital pen in a particular method independently for each user application, thereby enabling easy implementation of a user application that uses handwritten information by the digital pen.

According to yet another aspect of the present invention, there is provided a computer program product for data processing of the digital pen, in a computer readable medium, including instructions executed by a computer for causing the computer to implement a method to process address data printed on a paper and captured by the digital pen. The method includes associating position information of a specific area on the paper with processing type information indicating a processing type of data written in the specific area, generating handwritten information by analyzing address data captured by the digital pen and extracting handwritten information in a specific area based on position information of the specific area, executing data processing on the extracted handwritten information based on processing type information associated with the position information of the specific area, and storing processed data into a database accessible by a user application.

This configuration eliminates the need for designing and installing a program to provide a method of processing and storing handwritten information input by the digital pen in a particular method independently for each user application, thereby enabling easy implementation of a user application that uses handwritten information by the digital pen.

The present invention can provide a data processing system of the digital pen that enables easy implementation of a user application using handwritten information with the digital pen.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a view showing the overall configuration of a digital pen system of a related art;

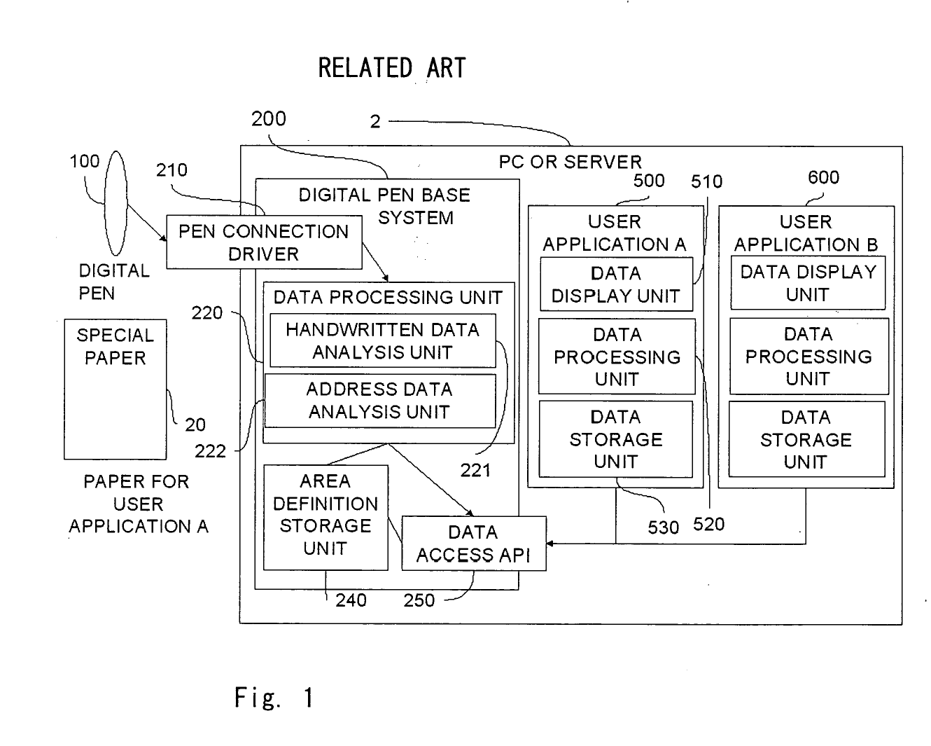

FIG. 2 is a view showing the overall configuration of the digital pen system according to an embodiment of the present invention;

FIG. 3 is a view showing the components of the digital pen according to an embodiment of the present invention;

FIG. 4 is a view showing a special paper according to an embodiment of the present invention;

FIG. 5 is a view showing the detailed configuration of the digital pen system according to an embodiment of the present invention;

FIG. 6 is a view showing an example of a PAD file according to an embodiment of the present invention;

FIG. 7 is a view showing an example of the configuration of a database according to an embodiment of the present invention; and

FIG. 8 is a view showing an example of a special paper according to an embodiment of the present invention.

### DESCRIPTION OF THE PREFERRED EMBODIMENTS

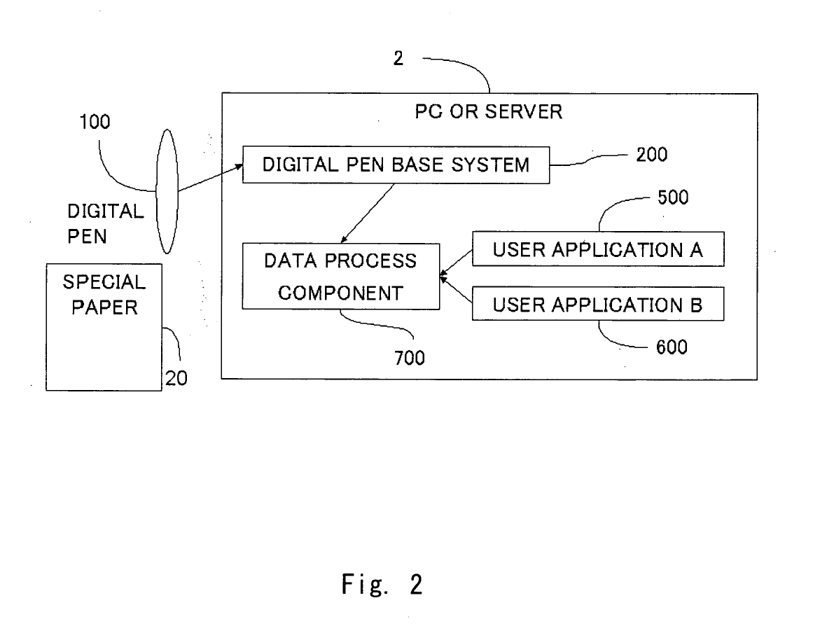

FIG. 2 is a schematic view showing the overall configuration of a data processing system of a digital pen according to an embodiment of the present invention. The data processing system of the digital pen uses Anoto functionality that is developed by Anoto Group AB.

Referring to FIG. 2, the data processing system of the digital pen according to the embodiment of the present invention includes the digital pen 100, a special paper 20, and a personal computer (PC) 2 that serves as a server (terminal). The digital pen 100 and the PC 2 are connected to be communicable with each other. A mobile terminal such as a mobile phone (not shown) may be placed between the digital pen 100 and the PC 2. In such a case, the digital pen 100 and the PC 2 are connected to be communicable via the mobile terminal. In this case, a special user application may be installed on the mobile terminal. Further, the data processing system of the digital pen may be configured so that the processing to be performed in the PC 2 is performed in the digital pen 100.

The digital pen 100 is used by a user to write information on the special paper 20. The digital pen 100 captures address data of handwritten information by reading a particular pattern that is printed on the special paper 20. The PC 2 is used as a destination to install components to process the address data or the like of the handwritten information that is captured by the digital pen 100. The PC 2 enables implementation of the digital pen base system 200, a data process component 700, a user application 500, a user application 600 and so on.

The digital pen base system 200 is a component that serves as a base for using the digital pen 100. The digital pen base system 200 includes driver software that is used for connection between the digital pen 100 and the PC 2, and a component such as a data processing unit to analyze address data captured by the digital pen 100.

The data process component 700 is a component that is used for the user application 500 or the user application 600 to acquire handwritten information data, and it is a feature of the present invention as described later. The user application 500 and the user application 600 are user applications to process handwritten information that is captured by the digital pen 100 according to a desired purpose of a user, and they are used in association with the special paper 20.

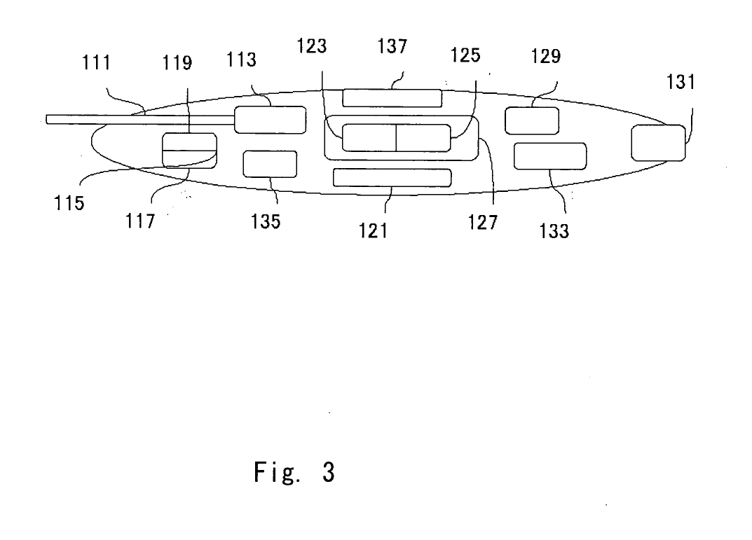

FIG. 3 is a view showing a detailed configuration of the digital pen 100. Referring to FIG. 3, the digital pen 100 includes an ink refill 111, a pressure sensor 113, an optical module 115, a camera 117, a light emitting device 119, a battery 121, a CPU 123, a memory 125, an information processing module 127, a clock 129, an USB (Universal Serial Bus) 131, a wireless communication processing unit 133, an vibrator 135, and a LED (Light Emitting Diode) 137. The CPU 123 and the memory 125 are included in the information processing module 127. The digital pen 100 may have any shape as long as it can write characters or symbols on the special paper 20.

The ink refill 111 contains ink to be transferred onto a paper for recording a written result just like a general writing pen. The pressure sensor 113 senses that a user is making handwriting input using the digital pen 100 or detects a handwriting pressure. The pressure sensor 113 senses a pressure during handwriting input.

The optical module 115 detects the light from the light emitting device 119 by receiving it with the camera 117. The camera 117 receives the light that is emitted from the light emitting device 119 and reflected by the special paper 20. The light emitting device 119 emits light to be received by the camera 117. Although an infrared ray is used in this example, light of another wavelength may be used as long as it can be received by the camera 117 and detected by the optical module 115.

The battery 121 supplies power to each component of the digital pen 100. The CPU 123 controls the digital pen 100. The memory 125 stores data in the digital pen 100. The clock 129 measures the time during which handwriting input is performed. The USB 131 transfers address data or the like that is captured by the digital pen 100 to electronic equipment that is connected thereto.

The wireless communication processing unit 133 transmits address data or the like to other electronic equipment having a wireless communication unit. The wireless communication may be based on Bluetooth (registered trademark), although not limited thereto. The data processing system of the digital pen according to this embodiment is operable if it includes either one, not both, of the USB 131 and the wireless communication processing unit 133.

The vibrator 135 notifies information to a user by vibration. The LED 137 notifies information to a user by lighting-up or blinking. Information can be notified to a user if either one, not both, of the vibrator 135 and the LED 137 is placed. Alternatively, information may be notified by sound such as buzzer.

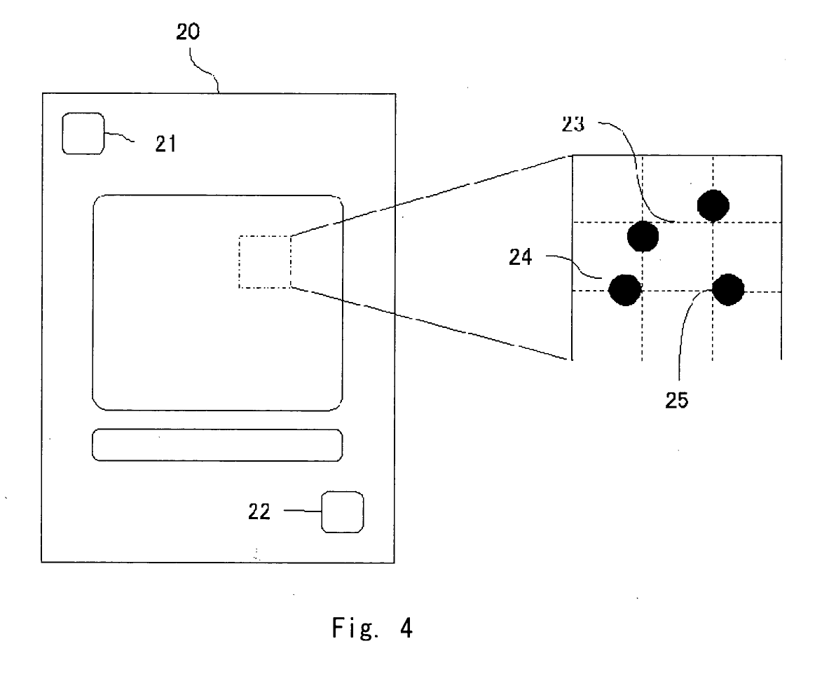

The configuration of the special paper 20 is described hereinbelow with reference to FIG. 4. The special paper 20 is a sheet that is qualified by Anoto Group AB. By making handwriting input onto the special paper 20 with the use of the digital pen 100, coordinate information or the like of the handwritten information can be captured.

Referring to FIG. 4, dots 24 having the same diameter are printed on the special paper 20 in such a way that the outer periphery of each dot is in contact with each intersection 25 of a grid 23 at regular intervals. The dots 24 may be printed with a color which cannot be identified by human eyes as long as it can be detected by the optical module 115. For example, if the camera 117 is an infrared ray camera, the dots 24 can be detected by the optical module 115 if the entire sheet 20 reflects an infrared ray and the dots 24 are printed with an ink that absorbs an infrared ray.

Further, the grid 23 is not necessarily an actual visible grid, and it may be an imaginary grid. As the interval of the grid 23 is shorter, higher resolution images can be obtained. In this embodiment, the interval of the grid 23 is preferably about 0.3 mm in consideration of the reading accuracy of the optical module 115. In such a case, the diameter of each dot 24 is preferably 80 μm to 120 μm. However, those values are not particularly limited.

Each dot 24 is printed at the position that is deviated from the intersection 25 of the grid 23 in any of the upward, downward, leftward and rightward directions. The information of the four, i.e. the upward, downward, leftward and rightward, directions can serve as 2-bit information. Specifically, one dot 24 has 2-bit information, and the 36 (6×6) intersections 25 and the dots 24 located at the upper, lower, left or right side of the intersections 25 have 72 (6×6×2) bit information. In the special paper 20, the position of the dot 24 in the upward, downward, leftward and rightward directions varies by each region of the 36 (6×6) intersections 25, and it is recorded as address data of handwritten information.

The digital pen 100 takes an image of the special paper 20 about 50 to 100 times per second using the camera 117, detects the positions of the dots 24 using the optical module 115, and captures address data of handwritten information on the special paper 20 from the detected positions. The digital pen 100 can thereby record where on the special paper 20 a user makes handwriting input.

Unique address data is assigned to each special paper 20, so that a different application can be associated with each special paper 20. Further, if a different page address is assigned to each page of the special paper 20, different processing may be performed for each page.

There is a region called a pidget 21 at the upper left of the special paper 20. When a user checks the pidget 21 with the digital pen 100, the optical module 115 obtains the position information of the pidget 21. The digital pen 100 is programmed to update a page upon obtaining address data of the pidget 21. The handwritten information before checking the pidget 21 and the handwritten information after checking the pidget 21 are thereby treated as image data of different pages without being superposed on one another when converting the handwritten information into image data.

There is also a region called a pidget 22 at the lower right of the special paper 20. When a user checks the pidget 22 with the digital pen 100, the optical module 115 obtains the position information of the pidget 22. The digital pen 100 is programmed to transmit data upon obtaining position information of the pidget 22. The digital pen 100 thereby transmits address data of handwritten information to the connected PC 2 through the USB 131 or the wireless communication processing unit 133. In this manner, a user enables transmission of the address data or the like of handwritten information which is stored in the digital pen 100 to the connected PC 2 by checking the region of the pidget 22 with the digital pen 100.

Besides, the special paper 20 can process various information by using particular codes in addition to the position of the dots 24. For example, if a pidget to designate a color is placed and information to designate a color is stored into the region, it is possible to convert the handwritten information after checking the pidget into image data with a designated color. Further, if a pidget to designate a size is placed and information to designate a size is stored into the region, it is possible to convert the handwritten information after checking the pidget into image data with a designated size.

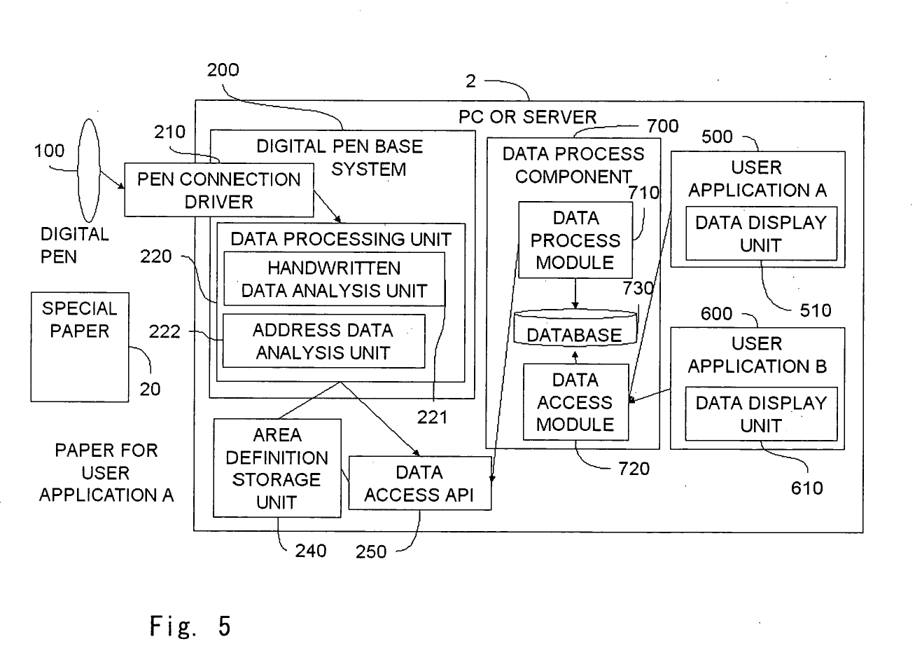

FIG. 5 is a view that shows details of the components of FIG. 2. The digital pen 100 transmits address data or the like of handwritten information that is written on the special paper 20 to a data processing unit 220 of the digital pen base system 200 through a pen connection driver 210 of the PC 2.

The data processing unit 220 serves as a first data processing unit that generates handwritten information by analyzing the address data that is captured by the digital pen 100 and extracts handwritten information in a specific area based on position information of a specific area that is stored in an area definition storage unit 240. The data processing unit 220 includes a handwritten data analysis unit 221 and an address data analysis unit 222.

The address data analysis unit 222 of the data processing unit 220 receives address data from the digital pen 100 and analyzes which special paper 20 the received address data is written on. The handwritten data analysis unit 221 of the data processing unit 220 extracts the address data in a specific area as handwritten information data based on area definition information that is stored in the area definition storage unit 240.

The area definition information is stored in the area definition storage unit 240 as a PAD (Paper Application Definition) file. The PAD file contains each page address of the special paper 20 that is associated with a user application, position information of a specific area that is formed on each page, processing type information of handwritten information data that is written on the area, identification information of the area, and so on. The processing type information of handwritten information data written on the area, the identification information of the area and so on are named according to a rule described below, so that they designate a processing method of the handwritten information corresponding to each area of each page of the special paper 20.

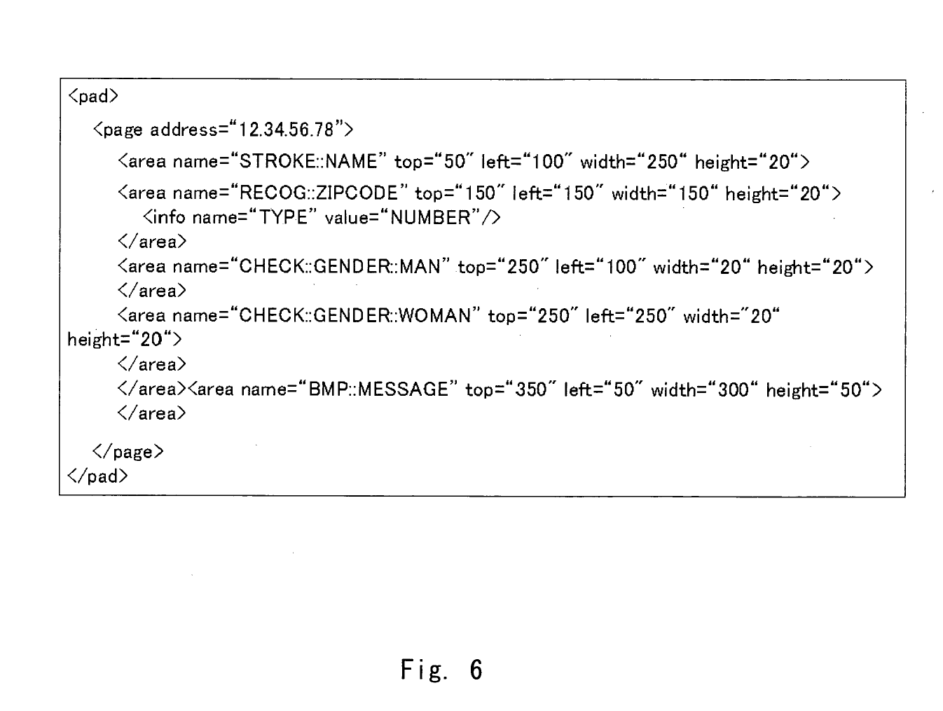

FIG. 6 shows a part of an exemplary PAD file. In this example, a PAD file is in XML (Extensible Markup Language) format. The format of a PAD file is not limited thereto as long as it can correctly indicate the information about the area of each page of the special paper 20. Although a PAD file is typically created with the use of a special area definition tool having a graphical interface, a method to create a PAD file is not limited thereto.

Referring to FIG. 6, “page address” defines a page address that is a unique address for each page of the special paper 20, and “12.34.56.78” is shown by way of illustration. The special paper 20 is associated with a corresponding user application, and the user application that is associated with the special paper 20 can be identified based on the page address which is contained in the address data that is written with the digital pen 100.

Referring still to FIG. 6, “area name” defines an area name and position information of the area in a page. The position information of an area in a page defines the position and the size of each area that is formed in a page. For example, the position of an area is defined by “top” and “left”, and the size of each area is defined by “width” and “height”.

An area name contains processing type information that is associated with position information of a specific area and identification information of a specific area, and it is named like “processing type information::identification information”. The processing type information defines a processing method as to in what format handwritten information data of a specific area is processed and obtained. The identification information defines a unique name of each area. In addition to the processing type information, attribute information that is defined as “info name”, “value” or the like, which is described later, may be included, for example. This enables processing of handwritten information data by designating advanced conditions in a processing method using processing type information.

For example, the following naming may be used for processing type information. The naming described hereinbelow is shown by way of illustration only, and other naming may be used as long as a method of obtaining handwritten information data can be uniquely identified from the name or attribute of an area.

In order to cause a data process module 710 of the data process component 700 to obtain stroke data of handwritten information in an area, it is named “STROKE::AREA_ID”. “STROKE” means output of stroke data of handwritten information, and “AREA_ID” is a unique name for a specific area, which is identification information. The stroke data means continuous data of a coordinate value of handwriting that is written with the digital pen 100, and it is represented as coordinate data on a X-axis coordinate or a Y-axis coordinate, for example. Besides a coordinate value of handwriting, a handwriting pressure, a stroke color or size on each coordinate may be obtained, and the information to be obtained is not limited thereto.

In the example of FIG. 6, “STROKE::NAME” means that the handwritten information such as a coordinate, a stroke color and size that is written on the area “NAME” is output as a text file to a database 730 by the data process module 710 of the data process component 700.

In order to cause the data process module 710 of the data process component 700 to recognize handwritten information in an area as characters or graphics and obtain a character string or the like as its result, it is named “RECOG::AREA_ID”. “RECOG” means output of a character string or the like as a result of character recognition or graphic recognition of handwritten information, and “AREA_ID” is a unique name for a specific area.

Further, the use of attribute information for the processing type information enables processing with designation of advanced conditions. For example, if “info name” is “ENGINE” and “value” is “ENGINE 1”, it is possible to perform recognition with the use of a recognition engine that is designated by “ENGINE 1” selected from a plurality of recognition engines. The recognition attribute may be designated in various ways according to a type of a recognition engine, and it is not limited thereto. For another example, if “info name” is “TYPE” and “value” is “NUMBER”, it is possible to recognize handwritten information that is written on a specific area as numbers. The recognition attribute is not limited to particular form such as numbers or graphics.

Referring again to FIG. 6, “RECOG::ZIPCODE” means that the handwritten information that is written on the area “ZIPCODE” is recognized as characters or graphics. Because “NUMBER” is designated in the “TYPE” attribute, it means that the handwritten information is recognized as numbers by the data process module 710, and the recognized character string is output to the database 730.

In order to cause the data process module 710 of the data process component 700 to identify the area that is the last to be checked by the digital pen 100 among a plurality of related areas, for example, when identifying the last checked area among three areas, three areas are put together as an area group and respectively named as “CHECK::AREA_ID::ITEM_1”, “CHECK::AREA_ID::ITEM_2”, and “CHECK::AREA_ID::ITEM_3”. Then, if the last checked area is “CHECK::AREA_ID::ITEM_2”, for example, the character string of “ITEM_2” is output to the database 730 by the data process module 710.

In the example of FIG. 6, regarding the two areas “CHECK::GENDER::MAN” and “CHECK::GENDER::WOMAN”, the name of the area that it input finally by the digital pen 100, which is “MAN” or “WOMAN”, is output to the database 730 by the data process module 710. It is thereby possible to identify the last checked area among a plurality of related areas.

In order to cause the data process module 710 of the data process component 700 to cancel a check that is made in an area by the digital pen 100 among a plurality of related areas, it is named “CHECK::AREA_ID::CANCEL”, for example. Then, if an area “CHECK::AREA_ID::CANCEL” is checked by the digital pen 100, the data process module 710 cancels the checks in all the areas beginning with “CHECK::AREA_ID” that have been made before “CHECK::AREA_ID::CANCEL” is checked. It is thereby possible to cancel the checks in a plurality of related areas.

In order to cause the data process module 710 of the data process component 700 to identify all the areas checked by the digital pen 100 among a plurality of related areas, for example, when identifying the checked areas among three areas, three areas are put together as an area group and respectively named as “MCHECK::AREA_ID::ITEM_1”, “MCHECK::AREA_ID::ITEM_2”, and “MCHECK::AREA_ID::ITEM_3”. Then, if the areas named “MCHECK::AREA_ID::ITEM_2” and “MCHECK::AREA_ID::ITEM_3” are checked by the digital pen 100, the data process module 710 outputs the character strings “ITEM_2, ITEM_3” to the database 730. It is thereby possible to identify all checked areas among a plurality of related areas.

Then, if the area “MCHECK::AREA_ID::CANCEL” is checked by the digital pen 100, the checks in all the areas beginning with “MCHECK::AREA_ID” that are made before “MCHECK::AREA_ID::CANCEL” is checked can be canceled, as is the case with “CHECK::AREA_ID::CANCEL”.

In order to cause the data process module 710 of the data process component 700 to obtain handwritten information of an area that is written with the digital pen 100 as an image file, it is possible to designate the format of an image file to be obtained. For example, to obtain handwritten information of an area as an image file of BMP (Bitmap) format, an area is named “BMP::AREA_ID”. “BMP” means to obtain information in the BMP format, and “AREA_ID” is a unique name for a specific area. Likewise, to obtain an image in JPEG (Joint Photographic Coding Experts Group) format, an area is named “JPEG::AREA_ID”. The format of an image file may be other formats such as PNG (Portable Network Graphics) format and TIFF (Tagged Image File Format) format, although not limited thereto.

In the example of FIG. 6, “BMP::MESSAGE” means that handwritten information that is written in the area “MESSAGE” by the digital pen 100 is output as an image file of the BMP format to the database 730 by the data process module 710.

In order to cause the data process module 710 of the data process component 700 to obtain handwritten information of an area input by the digital pen 100 as an image that is superposed onto a predetermined background image, an area is named “BMPBG::AREA_ID”, for example. It is thereby possible to obtain handwritten information of an area input by the digital pen 100 as an image that is superposed onto a predetermined background image.

The data process component 700 shown in FIG. 5 is described hereinafter. The data process component 700 serves as a second data processing unit that executes data processing on the extracted handwritten information based on the processing type information that is associated with position information of a specific area in the area definition storage unit 240 and stores the processed data into a database to which a user application is accessible.

The data process component 700 includes the data process module 710, a data access module 720, and the database 730.

When address data is transmitted to the data processing unit 220, the data process module 710 of the data process component 700 is invoked, and the data process module 710 accesses a data access API 250 of the digital pen base system 200 to obtain handwritten information. The data process module 710 outputs the obtained handwritten information data to the database 730 based on the area definition information that is stored in the area definition storage unit 240. A user application accesses the database 730 via the data access module 720 to obtain the handwritten information of each area that is stored in a desired format, and displays a result to a user using a data display unit 510.

The operation of the data process module 710 of the data process component 700 is described hereinafter in detail. The data process module 710 is invoked when the address data that is written by the digital pen 100 is transmitted to the data processing unit 220 and accesses the handwritten information data that is processed by the handwritten data analysis unit 221 via the data access API 250. At this time, the data process module 710 extracts the PAD file that defines corresponding area definition information from the area definition storage unit 240 based on a page address of address data that is analyzed by the address data analysis unit 222 of the data processing unit 220.

The extracted PAD file contains position information of a specific area of each page in the special paper 20, processing type information that specifies a processing method of handwritten information data that is written in the area, and so on. The data process module 710 processes the handwritten information that is written in each area according to the specified processing method and outputs a result to the database 730. Thus, the data process module 710 sequentially examines the handwritten information of each area in each page of the special paper 20 and processes the handwritten information data of each area in a desired format based on the processing type information or the like that is associated with position information of each area.

If the processing type information is “STROKE”, for example, the data process module 710 outputs stroke information of the handwritten information that is written in a corresponding area as a text file to the database 730. In addition to the text file of the stroke information, the data process module 710 further stores information such as date and time when the writing by the digital pen 100 is made, unique information of the digital pen 100 used for the writing, a page address of the special paper 20 onto which information is written, into the database 730.

If the processing type information is “RECOG”, for example, the data process module 710 recognizes the handwritten information data that is written in a corresponding area as characters or graphics and outputs a character string or the like as a recognition result to the database 730. At this time, if “info name” indicating attribute information is defined as “ENGINE” and “value” indicating the value of the attribute designates “ENGINE 2”, the data process module 710 recognizes the handwritten information with the use of a recognition engine that corresponds to “ENGINE 2”. If the “ENGINE” attribute is not defined, a recognition engine that is incorporated in the data processing system of this embodiment may be used.

If “info name” is defined as “TYPE” and “value” designates “NUMBER”, the handwritten information data that is written in a corresponding area is recognized as numbers. In addition to a character string as a recognition result, information such as date and time when the writing by the digital pen 100 is made, unique information of the digital pen 100 used for the writing, a page address of the special paper 20 onto which information is written is also stored into the database 730.

If the processing type information is “CHECK”, for example, the data process module 710 identifies the area that is the last to be checked by the digital pen 100 among a plurality of related areas and outputs a unique name of the area to the database 730. For example, if “CHECK::AREA_ID::ITEM_ID” is designated, the area that is finally checked by the digital pen 100 is identified among all the areas that contain “CHECK::AREA_ID” as an area name based on description time information that is contained in stroke information of handwritten information data that is written in the area. Then, “ITEM_ID”, which is a unique name of the area, is output to the database 730. In addition to the unique name of the last checked area, information such as date and time when the writing by the digital pen 100 is made, unique information of the digital pen 100 used for the writing, a page address of the special paper 20 onto which information is written is also stored into the database 730.

If the processing type information is “MCHECK”, for example, the data process module 710 identifies the area that is checked by the digital pen 100 among a plurality of related areas and outputs a unique name of the area to the database 730. For example, if “MCHECK::AREA_ID::ITEM_ID” is designated, the area that is checked by the digital pen 100 is identified among all the areas that contain “MCHECK::AREA_ID” as an area name based on the handwritten information data that is written in the area. Then, a character string that divides the portion of “ITEM_ID”, which is a unique name of each checked area, by a comma, i.e. a character string of “ITEM_ID1, ITEM_ID2, ITEM_ID4”, is output to the database 730. In addition to the unique name of each checked area, information such as date and time when the writing by the digital pen 100 is made, unique information of the digital pen 100 used for the writing, a page address of the special paper 20 onto which information is written is also stored into the database 730.

If the processing type information is “BMP”, for example, the data process module 710 outputs a stroke image of the handwritten information data that is written in an area as a file of BMP format to the database 730. In addition to the stroke image file, the data process module 710 stores information such as date and time when the writing by the digital pen 100 is made, unique information of the digital pen 100 used for the writing, a page address of the special paper 20 onto which information is written, into the database 730.

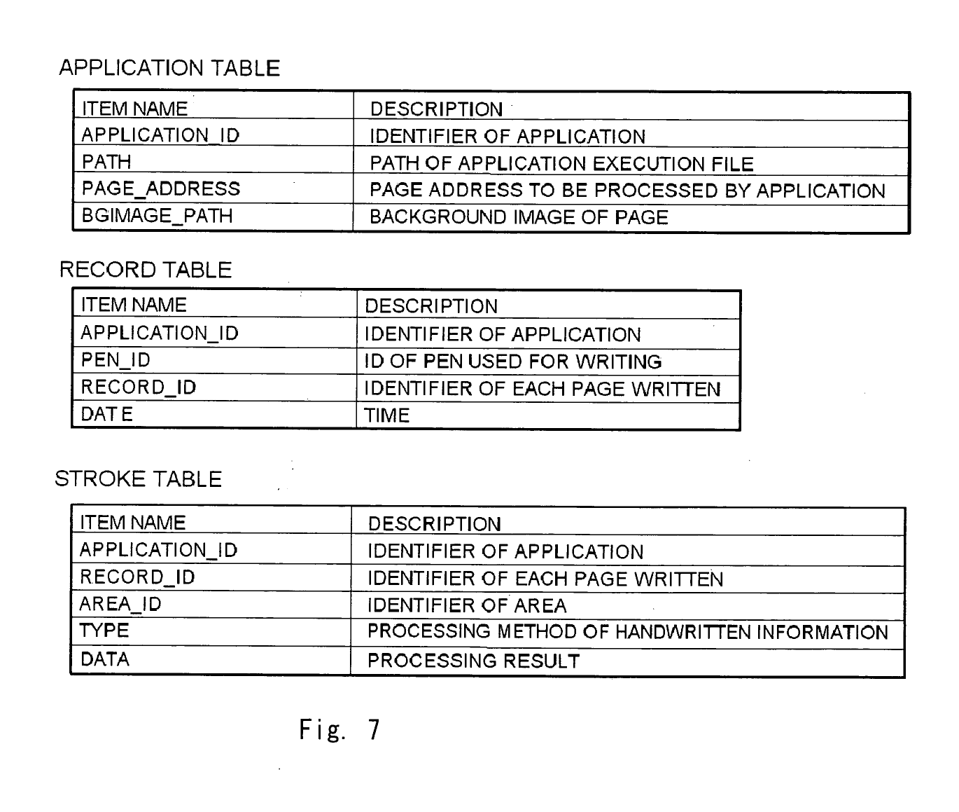

The database 730 of the data process component 700 is described hereinafter in detail. FIG. 7 shows a table that forms the database 730. The database 730 contains an application table, a record table, and a stroke table. The table definitions that are shown therein are given by way of illustration only, and they may be varied as appropriate according to a system and an application as long as necessary data can be retrieved correctly.

The application table stores information about user applications. A corresponding unique identifier “APPLICATION_ID” is assigned to each of all user applications. A storage location of an execution file of the user application is designated by “PATH”. A page address of the special paper 20 to be processed by the user application is designated by “PAGE_ADDRESS”. If there is a background image of the special paper 20 to be processed by the user application, its storage location is designated by “BGIMAGE_PATH”.

The record table stores handwritten information data of each page of the special paper 20, on which is information is written using the digital pen 100. The handwritten information data that is transmitted from the digital pen 100 is managed for each page, and a corresponding unique identifier “RECORD_ID” is assigned to each page. The data and time when information is written on the page by the digital pen 100 is designated by “DATE”, and an identifier of the digital pen 100 that is used for the writing is designated by “PEN_ID”.

The stroke table stores handwritten information data of each area. The handwritten information data that is transmitted from the digital pen 100 is managed for each area, and a corresponding unique identifier “AREA_ID” is assigned to each area. An output format or the like of the handwritten information that is written in the area is designated by “TYPE”, and a final result of the handwritten information data that is processed by the data process module 710 is stored in “DATA”. The format of the handwritten information data that is stored in “DATA” differs depending on a designated “TYPE”.

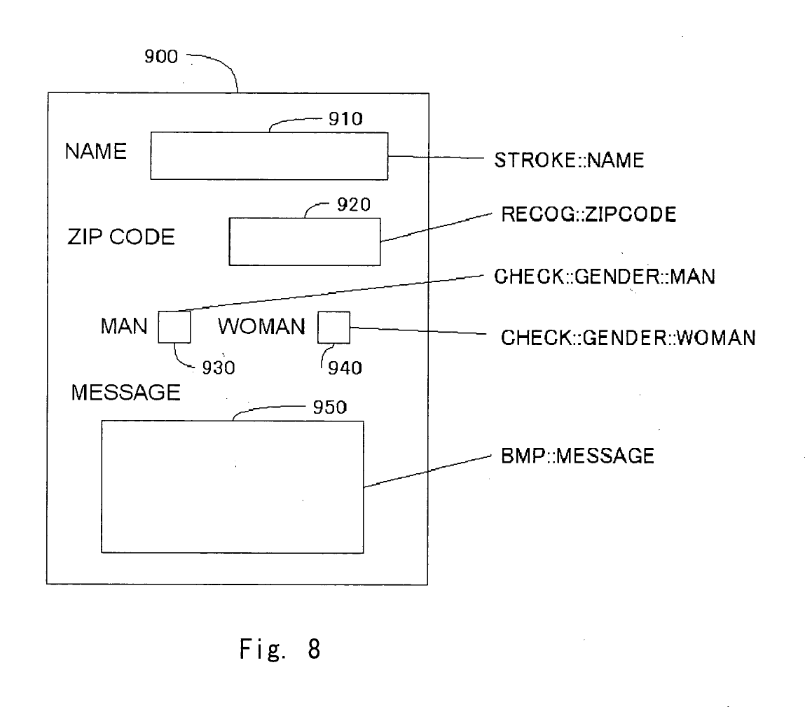

The operation of the data processing system according to the embodiment of the present invention is described hereinafter with the use of a more detailed example. FIG. 8 shows a message form 900 as an example of the special paper 20. The message form 900 includes a name field 910, a zip code field 920, a man check field 930, a woman check field 940, and a message field 950.

In a PAD file, a page address corresponding to the message form 900, and position information and processing type information of each area corresponding to the name field 910, the zip code field 920, the man check field 930, the woman check field 940 and the message field 950 are defined.

The area definition information corresponding to the name field 910 is named “STROKE::NAME”, for example, so as to obtain the stroke information of handwriting that is written in the name field 910. The area definition information corresponding to the zip code field 920 is named “RECOG::ZIPCODE”, for example, so as to obtain the handwritten information that is written in the zip code field 920 as numerical data.

The area definition information corresponding to the man check field 930 and the woman check field 940 is named “CHECK::GENDER::MAN” and “CHECK::GENDER::WOMAN”, respectively, for example, so as to determine which of the man check field 930 and the woman check field 940 is checked.

The area definition information corresponding to the message field 950 is named “BMP::MESSAGE”, for example, so as to obtain the handwritten information that is written in the message field 950 as a file of an image format. The area definition information is the same as that in the PAD file shown in FIG. 6.

In the application table of the database 730, the information about a user application corresponding to the message form 900 is defined.

For example, in “APPLICATION_ID” that indicates an identifier of an application, “MESSAGE_PAPER” that indicates a user application to process the message form 900 is written. In “PATH” that indicates a path to an execution file of an application, “C:¥messagepaper.exe” that indicates the location where the execution file exists is written. In “PAGE_ADDRESS” that indicates a page address to be processed by an application, “12.34.56.78” that is the page address of the message form 900 is written. In “BGIMAGE_PATH” that indicates a background image of a page, “C¥bg_image.bmp” that indicates the location where a background image file exists is written if there is a background.

If the above definitions are recorded in the application table, it is possible to identify a corresponding user application among prerecorded user applications based on a page address to thereby activate the user application to be available.

Further, if the recorded items are eliminated from the application table, the information on the association between the special paper 20 and a user application is eliminated to thereby treat the user application as being eliminated or no longer available.

The address data of the handwritten information that is written on the message form 900 by the digital pen 100 is transmitted from the digital pen 100 to the PC 2 through a communication means such as USB or Bluetooth, and then transmitted to the data processing unit 220 of the digital pen base system 200 through the pen connection driver 210 of the PC 2. Then, the page address of the address data that is transmitted from the digital pen 100 is identified by the address data analysis unit 222 and converted into handwritten information data by the handwritten data analysis unit 221.

After that, the data process module 710 of the data process component 700 is invoked, and the handwritten information data is processed in a desired format based on the area definition information of the PAD file that is stored in the area definition storage unit 240 through the data access API 250, and the processed handwritten information data is output to the database 730. Then, the user application 500 accesses the database 730 through the data access module 720, acquires the handwritten information data of each area which is obtained in the desired format, and displays a result for a user through the data display unit 510.

In the example described above, the data processing system of the present invention may be implemented on a server in a network, not only on the PC 2. When the system is implemented on a server in a network, data may be transmitted from the digital pen 100 to the server in the network through a mobile terminal such as a mobile phone. Alternatively, a location to transmit the address data that is captured by the digital pen 100 may not be limited, and the data processing system of the present invention may receive the address data that is captured by the digital pen 100 from any location and collect and manage the data all together in one location.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A data processing system of a digital pen, comprising:
a paper where address data is printed;
the digital pen to capture address data printed on the paper; and
a terminal connected to be communicable with the digital pen, to obtain the address data from the digital pen, the terminal including:
an area definition storage unit to store position information of a specific area on the paper and processing type information indicating a processing type of data written in the specific area in association with each other;
a first data processing unit to generate handwritten information by analyzing the address data captured by the digital pen and extract handwritten information in a specific area based on position information of the specific area stored in the area definition storage unit; and
a second data processing unit to execute data processing on the extracted handwritten information based on processing type information associated with the position information of the specific area in the area definition storage unit and store processed data into a database accessible by a user application.

2. The data processing system of the digital pen according to claim 1, wherein
the area definition storage unit further stores identification information of the specific area in association with the position information of the specific area and the processing type information.

3. The data processing system of the digital pen according to claim 2, wherein
the second data processing unit stores the identification information of the specific area in association with processed data into the database.

4. The data processing system of the digital pen according to claim 1, wherein
the processing type information stored in the area definition storage unit is information selected by a user from a predetermined plurality of pieces of processing type information.

5. The data processing system of the digital pen according to claim 1, wherein
the processing type information stored in the area definition storage unit contains any one of processing to convert the handwritten information into image information, processing to convert the handwritten information into stroke information, processing to convert the handwritten information into character recognition information, and processing to convert the handwritten information into information indicating presence or absence of handwritten information in the specific area.

6. A data processing terminal of the digital pen, connected to be communicable with the digital pen for capturing address data printed on a paper, to obtain the address data from the digital pen, the data processing terminal comprising:
an area definition storage unit to store position information of a specific area on the paper and processing type information indicating a processing type of data written in the specific area in association with each other;
a first data processing unit to generate handwritten information by analyzing the address data captured by the digital pen and extract handwritten information in a specific area based on position information of the specific area stored in the area definition storage unit; and
a second data processing unit to execute data processing on the extracted handwritten information based on processing type information associated with the position information of the specific area in the area definition storage unit and store processed data into a database accessible by a user application.

7. A computer program product for data processing of the digital pen, in a computer readable medium, including instructions executed by a computer for causing the computer to implement a method to process address data printed on a paper and captured by the digital pen, the method comprising:
associating position information of a specific area on the paper with processing type information indicating a processing type of data written in the specific area;
generating handwritten information by analyzing address data captured by the digital pen and extracting handwritten information in a specific area based on position information of the specific area;
executing data processing on the extracted handwritten information based on processing type information associated with the position information of the specific area; and
storing processed data into a database accessible by a user application.
